(19) United States
(12) Patent Application Publication
(10) Pub. No.: US 2010/0101164 A1
(43) Pub. Date: Apr. 29, 2010

(54) STRUCTURAL ELEMENT FOR A PROTECTIVE WALL

(76) Inventor: Bengt-Inge Broden, Skara (SE)

Correspondence Address: HOLLAND & HART, LLP, P.O BOX 8749, DENVER, CO, 80201, US

(21) Appl. No.: 12/520,191

(22) PCT Filed: Dec. 20, 2007
(86) PCT No.: PCT/SE07/01140

§ 371 Date: Nov. 3, 2009

(30) Foreign Application Priority Data
Dec. 20, 2006 (SE) 0602763-5
Sep. 7, 2008 (SE) 0702002-7

(51) Int. Cl. E04B 2/10; E06B 5/10; E04B 2/08; E04B 1/02; E04B 2/20; E04H 9/04

(52) U.S. Cl. 52/302.7; 52/588.1; 52/570; 52/745.09; 52/741.3; 109/58

(57) ABSTRACT

The present invention relates to a structural element comprising of a rigid, hollow body having upper and lower, essentially parallel sides and interjacent side sections and configured in such a way that it can be positioned above a similarly configured structural element, and that it is locked to prevent movement orthogonally in relation to a subjacent, similarly configured structural element by such positioning, and that the structural element comprises one filling orifice (3) on the upper side of the structural element and one drain orifice (4) on the lower edge of one of the side sections of the structural element.

### AREA OF THE INVENTION

The present invention relates to a structural element that is easy to transport and can be assembled together with additional, similarly configured structural elements in order rapidly to construct a temporary protective wall.

### BACKGROUND AND PRIOR ART

The use of sand bags, for example, to construct a protective wall to withstand flooding or bombs is previously disclosed. An advantage associated with such sand bags is that there is usually good access to sand or soil close to the point at which a river, for example, overflows, and it is easy to transport a large number of empty bags to a desired location. If, however, a river in a town overflows, it may prove difficult to obtain adequate supplies of sand or soil at a point sufficiently close to the overflow to ensure that not a single pre-filled sand bag requires to be transported over quite a long distance. If a single pre-filled sand bag requires to be transported over quite a long distance, much of the benefit of using empty sand bags to construct temporary protective walls is lost.

### BRIEF SUMMARY OF THE INVENTION

One object of the present invention is to make available a structural element for a protective wall, which structural element is easy to transport and, at the same time, can be assembled rapidly together with additional, similarly configured structural elements in order to construct a temporary protective wall.

The basis of the present invention is the knowledge that the above-mentioned objects can be achieved by means of structural elements which lock together and are readily capable of being filled with water and emptied of water.

The particular characteristics of a structural element according to the present invention are evident from claim 1.

One advantage of a structural element configured according to the present invention is that it is easy to transport when it is empty, and that, when it is locked together with subjacent, similarly configured structural elements and is filled with water, they combine to form a rapidly erected temporary protective wall.

The structural element is advantageously configured with a projection and a corresponding recess to permit its interaction with similarly configured structural elements.

In the case of a preferred structural element, a superabsorbent is contained in its cavity, so that added water is transformed into a gel-like mass in order to increase the capacity of the structural element to absorb splinters and pressure waves, for example from an exploding bomb.

A plurality of structural elements can be advantageously assembled to produce a protective wall comprising at least two courses with a plurality of structural elements according to the present invention.

The particular characteristics of a method for erecting a protective wall according to the present invention are evident from claim 11.

One advantage of the method of building a protective wall according to the present invention is that it is easy to transport the structural elements in the protective wall when they are empty, and that, when they are assembled, it is an easy and rapid operation to fill them with water in order to provide the protective wall with strength and stability. It is then easy to empty water from the building elements in the protective wall and to reuse undamaged structural elements subsequently for building a protective wall in a new location.

Further characteristic features and advantages of the present invention will be appreciated from the following description and the following Claims.

The invention will be described in more detail below with reference to the detailed description of embodiments and the accompanying Figures, which are provided for illustrative purposes only and are thus not restrictive for the present invention.

### BRIEF DESCRIPTION OF THE DRAWINGS

FIG. 1 depicts a first embodiment of a structural element according to the present invention in a perspective view from above;

FIG. 2 depicts the structural element in FIG. 1 in a perspective view from below;

FIG. 3 depicts an embodiment of an angled structural element according to the present invention in a perspective view;

FIG. 4 depicts the angled structural element in FIG. 3 in a plan view;

FIG. 5 depicts a structural element in FIG. 1 adjacent to a further, similarly configured structural element and a connecting structural element;

FIG. 6 depicts a connecting structural element according to an alternative embodiment compared with that depicted in FIG. 5;

FIG. 7 depicts a part of a protective wall comprising of a plurality of structural elements;

FIG. 8 illustrates schematically in a plan view a free-standing bomb shield constructed from a plurality of structural elements according to the present invention;

FIG. 9 illustrates schematically in a plan view a bomb shield constructed from a plurality of structural elements according to the present invention, which has been positioned against an existing wall;

FIG. 10 illustrates schematically in a plan view a free-standing bomb shield with a lock constructed from a plurality of structural elements according to the present invention;

FIG. 11 illustrates schematically in a plan view a check point constructed from a plurality of structural elements according to the present invention;

FIG. 12 illustrates schematically in a plan view a barrage constructed from a plurality of structural elements according to the present invention;

FIG. 13 depicts a second embodiment of a structural element according to the present invention in a perspective view from the front;

FIG. 14 depicts the structural element in FIG. 13 in a perspective view from the rear;

FIG. 15 depicts a section of a protective wall comprising a plurality of structural elements;

FIG. 16 depicts two parallel self-supported screens according to a third embodiment of the present invention;

FIG. 17 depicts a side elevation view of a protective wall according to a third embodiment of the present invention; and

FIG. 18 depicts the protective wall in depicted in FIG. 17 from another angle.

### DETAILED DESCRIPTION OF MODES FOR CARRYING OUT THE INVENTION

The following description gives specific details, such as particular techniques and applications, for explanatory rather than restrictive purposes, intended to provide a thorough understanding of the present invention. It will be obvious to a person skilled in the art, however, that the present invention can be configured in other embodiments which differ from these specific details. In other examples, a detailed description of previously disclosed methods and arrangements is omitted in order not to obfuscate the description of the present invention with unnecessary details.

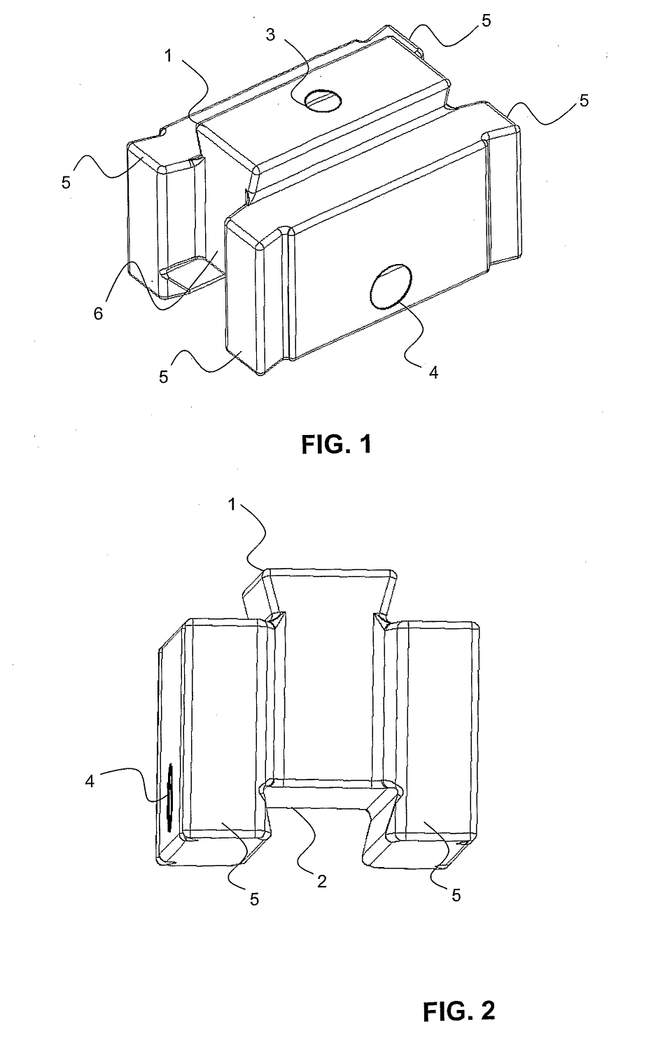

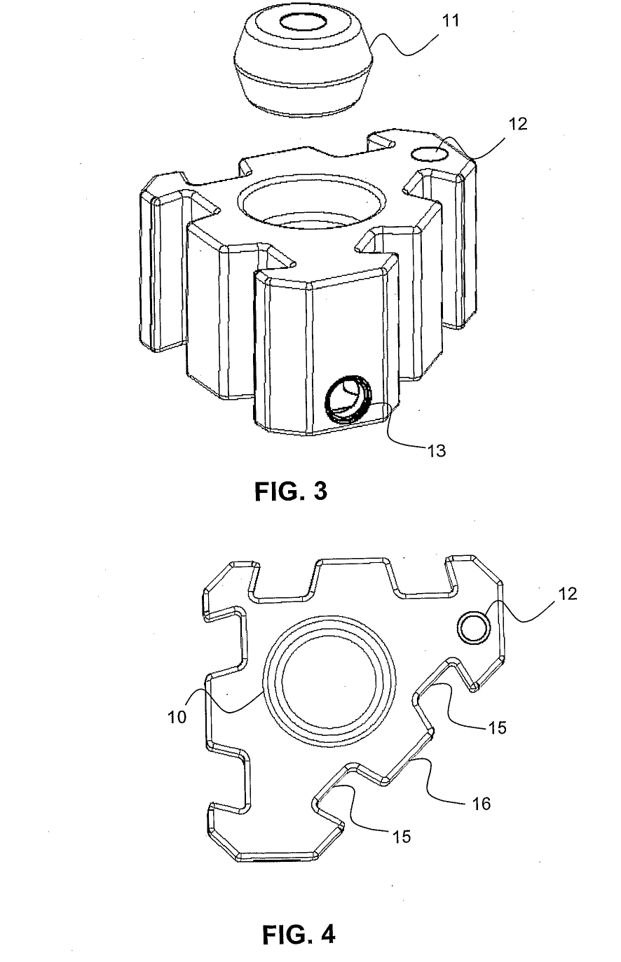

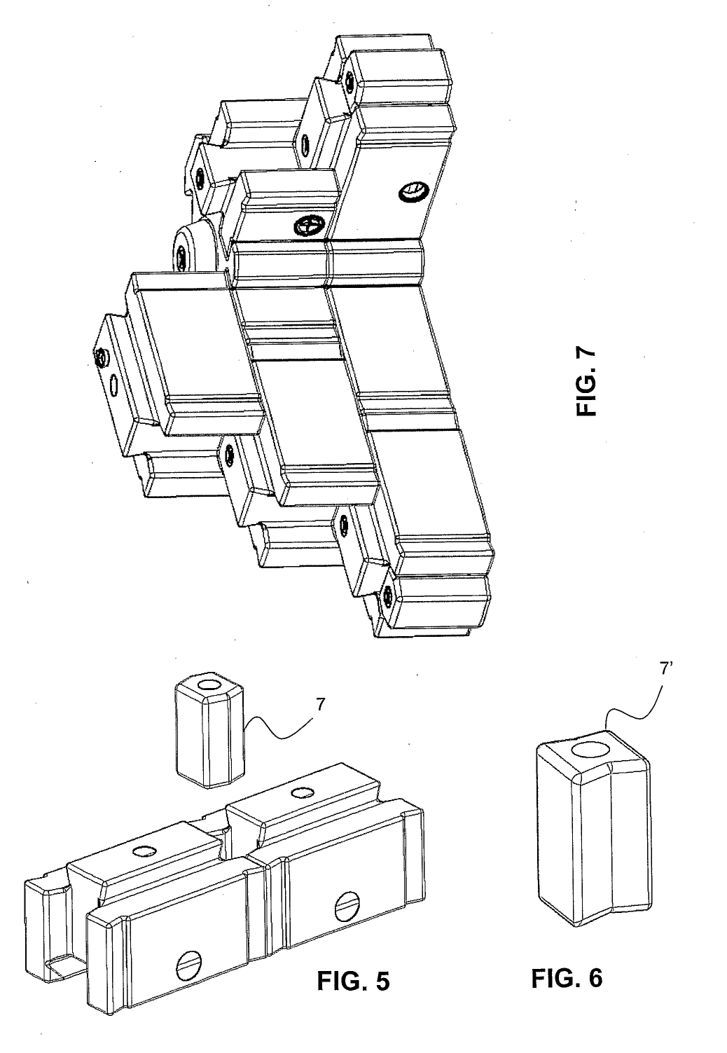

A first embodiment of a structural element according to the present invention is now described with reference to FIGS. 1-7.

The structural element is configured so that it is capable of being displaced back and forth in a direction towards a subjacent, similarly configured structural element. In directions other than the back and forth direction of displacement, the structural element is locked to prevent displacement relative to the subjacent, similarly configured structural element. This is achieved advantageously by means of a dovetail-shaped projection 1 on an upper supporting surface of the structural element and a corresponding lower recess on a lower supporting surface of the structural element. The projection 1 and the recess 2 can also be positioned inversely, although the structural element in this case makes contact with the ground over a larger area with the recess 2 facing in a downward direction, which gives greater stability. The structural element preferably has a generally right parallelepipedic form, for example 1200×800×600 mm. Assembly to form a temporary wall is facilitated by having a length that is twice as long as a width. Among other things, essentially parallel opposite sides, both the upper and lower sides and the interjacent sections of the sides, are obtained with a generally right parallelepipedic form. Dovetailing is an advantageously configured form of locking, although the projection and its corresponding recess can be configured in a large number of different ways to provide corresponding locking.

Furthermore, the structural element is rigid and hollow and has an upper filling orifice 3, preferably located at the highest point on the structural element, so that the structural element can be filled all the way to the top with water, and one or more lower drain orifices 4, preferably located on the lower edge of the long side of the structural element, so that it is easy to empty it of water. If the drain orifice 4 were to be arranged on the under side of the structural element, it would not be directly accessible for drainage of the water. Any water that is not emptied from the structural element directly via the opening in the lower drain orifice 4 can be easily tipped out of the structural element, which has a light weight after most of the water has been emptied out. The orifices 3 and 4 are sealed preferably with a threaded, countersunk lid.

An alternative to the upper filling orifice and the lower drain orifice is to have a filling orifice positioned low down, in which case water is filled under pressure through a reversible pressure valve. One small orifice, or a plurality of orifices, in the upper part of the structural element can be used to release air when water flows in under pressure, and to admit air when water is drained out through the reversible pressure valve. It is also possible to connect all the structural elements in a protective wall together, so that all the structural elements can be filled with liquid by filling from a single connection point.

The structural element is empty of water during transport and as such is light in weight. When the structural element is transported from a storage place or a previous place of use, it is positioned in a desired location and filled with water via the upper filling orifice 3. When the structural element is to be taken out of service, the water contained in the structural element is emptied via the lower drain orifice 4.

The structural element preferably also includes dovetail-shaped projections 5 on its short ends to permit its displacement in a direction up and down in relation to an angled structural element. The dovetail-shaped projection intended for interaction with an angled structural element is configured orthogonally in relation to the dovetail-shaped projection intended for interaction with a subjacent structural element. The structural element is illustrated with a recess 6 in its dovetail-shaped projection on its short sides in order to permit the locking of two adjacent structural elements, as described in more detail below.

A protective wall is constructed from a plurality of similarly configured structural elements by positioning a first course of structural elements one after the other in a straight line on the ground. When the first course has been laid, all the structural elements contained therein are filled with water. A new course of structural elements is then pushed onto the first course. The fact that the new course is dovetailed to the subjacent course produces a protective wall that is capable of supporting itself without mortar, adhesive or the like. The new course is laid with the joints between its structural elements displaced relative to the joints in the subjacent course, in order to provide increased strength by forming connections between the courses, compared with the situation in which the joints between the structural elements in one course are arranged directly over the joints in a subjacent course. Once the second course has also been laid in position, all of its structural elements are filled with water. It is then possible to build on more courses in a corresponding manner until the desired height of the protective wall is reached.

The fact that offset joints are used means that every alternate course will project from the respective subjacent and superjacent course at the ends of the protective wall. In order to be able to obtain a protective wall with straight ends and, at the same time, with offset joints in the courses, a structural element with half the length can be used appropriately in order to offset the structural elements in different courses relative to one another.

If the protective wall is required to exhibit a form other than a straight line, angled structural elements are pushed down through dovetail-shape projections 15 for the purpose of locking in desired positions in the protective wall. The recesses 15 can contain projections 16 to correspond to the recesses 6 in the structural elements. An angled structural element is preferably configured with a cross section in the form of a right-angled triangle, in order to provide the possibility of both four-sided and six-sided design solutions for temporary protective walls. In order to permit the use of an angled structural element, with a cross section in the form of a right-angled triangle, at ±45° and ±90°, the angled structural element is configured advantageously with a recess 10 in its upper side and lower side intended to receive a separate connecting element 11. These angled structural elements are also hollow and contain an upper filling orifice 12 and a lower drain orifice 13.

An angled element can also be configured in a manner other than an equilateral triangle. An angled structural element can also be configured with a dovetail-shaped projection and a structural element with a corresponding recess. A connecting structural element can be configured in this way with a dovetail-shaped form for locking two adjacent structural elements, although a connecting structural element of this kind can be difficult to lift from the protective wall because it is difficult to empty it of water before lifting it from the protective wall.

When structural elements with recesses in their short sides are positioned adjacent to one another in a row, a cavity 6 is obtained between them. These cavities are filled advantageously with a connecting structural element 7. This connecting structural element also contains upper filling orifices and lower drain orifices. The connecting structural element 7 provides support for the next course and fills up the supporting wall, which is particularly advantageous when it is used as a bomb shield. An alternative embodiment of a connecting structural element 7′ is depicted in FIG. 6, where it exhibits a double dovetail-shaped form. A double dovetail-shaped connecting structural element 7′ provides a locking function between adjacent structural elements.

If the protective wall is to be used as a bomb shield, for example when a suspected unexploded bomb is to be disarmed or detonated, each structural element can be provided advantageously with a superabsorbent inside its cavity. A structural element that is only filled with water has a considerable capacity to absorb the force contained in splinters and shock waves from an exploding bomb. However, the gel-like mass, or gel, which is formed by water combined with a superabsorbent, possesses an even greater absorption capacity than water alone, and it is also easy to empty this gel from a structural element that has not been destroyed by disarming or detonation, so that the structural element can be reused. In order to facilitate the removal of all the gel from a structural element, its cavity can be flushed with water.

If the bomb that is to be disarmed is very powerful, several ranks of protective walls can be placed advantageously parallel with one another to provide stronger shielding. In the case of truly extreme bombs, for example a howitzer shell, layers of protective armour can be added to a structural element to provide greater protection in the form of one or more of the following layers: plywood, metal mesh, asfaboard, Kevlar and non-woven layers.

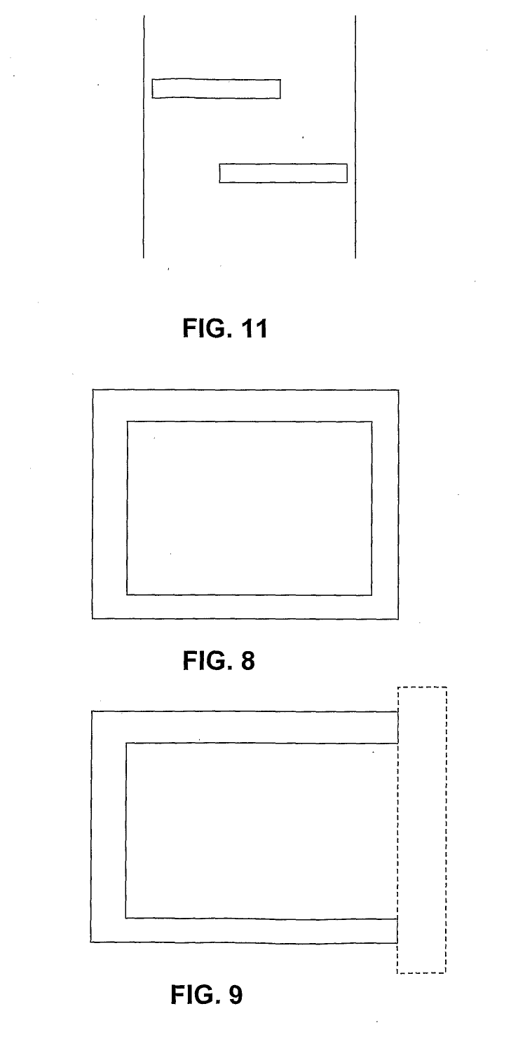

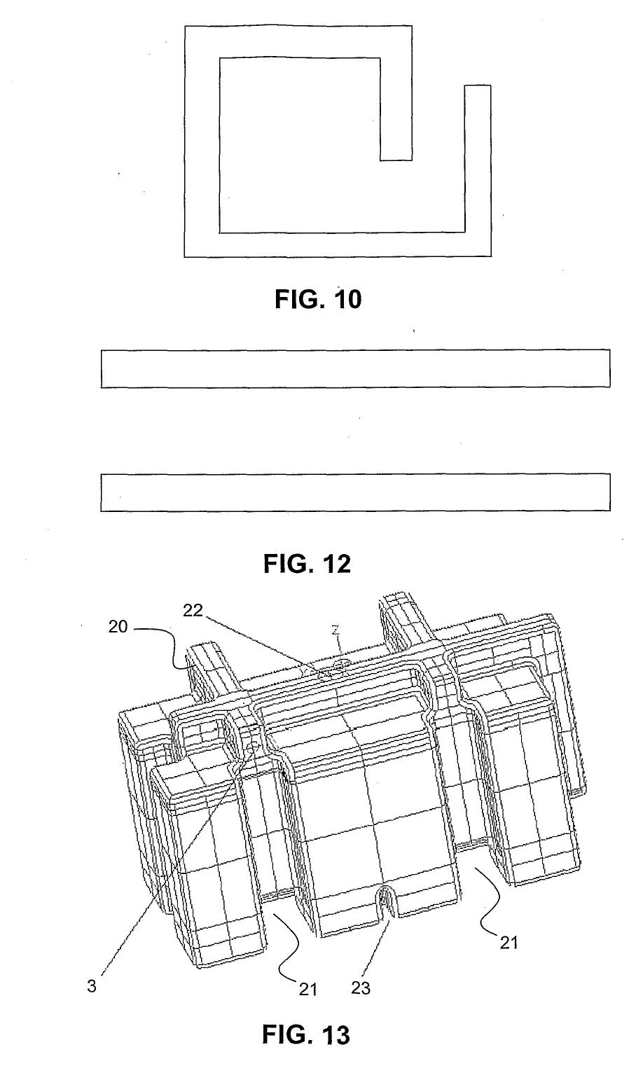

A rectangular-shaped protective wall can be constructed appropriately around a suspected unexploded bomb to provide protection on all sides; see the illustration in FIG. 8. A horseshoe-shaped protective wall can be appropriately constructed to provide protection in every direction except for an existing wall; see the illustration in FIG. 9. An alternative to installing a bomb disposal robot or a similar detonating means behind a protective wall containing a bomb is to construct the protective wall in such a way that it incorporates a form of lock, see the illustration in FIG. 10, which provides an access route to the bomb for a bomb disposal robot, for example, without the robot being enclosed together with it, yet at the same time provides protection in all directions. With a protective wall around an exploding bomb, the pressure wave from it is propelled upwards, which is desirable. An exploding bomb normally also distributes splinters, however, which are arrested by the protective wall in horizontal directions, but not upwards. If shielding against splinters is also required in the upward direction, a traditional, so-called blast mat can be used advantageously as a roof.

Protective walls according to the present invention can also be used as a check point on a wall, that is to say to obstruct the advance of a car bomb; see the illustration in FIG. 11.

For the purposes of a barrage, a protective wall with extreme strength can be obtained by first constructing two essentially parallel rows of structural elements, see the illustration in FIG. 12, and by then filling the space between the rows with sand using an excavator or the like. In order to reduce the pressure acting on a protective wall in a barrage, structural elements with ducts can be used advantageously to drain water from the barrage in a controlled manner and without the risk of undermining the protective wall. In addition, structural elements in a protective wall can be provided with eyes, for example, enabling them to be secured to the ground with cables or ropes, preferably on the water side of the protective wall, in a manner that is particularly appropriate for barrages. Alternatively, a protective wall can be arranged with angled structural elements, which continue not only along the barrage, but also across the barrage from the water side of the protective wall, in a manner that is particularly appropriate for barrages. In order further to prevent the ingress of water into the protective wall, a rubber sheet, tarpaulin or the like can be laid under the wall and up along the water side of the wall, and can be clamped between the two topmost courses in the wall.

A further area of application for a protective wall according to the present invention is in the construction of emergency accommodation. By filling the structural elements with polyurethane foam or the like, additionally improved insulation of the emergency accommodation is achieved by comparison with empty structural elements.

In order to provide a protective wall according to the present invention with additional reinforcement, a dovetail-shaped steel beam can be laid on the ground as the first course with structural elements pushed on. In this way, the first course already possesses strong retaining force.

An advantageous choice of material for the structural element is PE (polyethylene) or similar, which is environmentally friendly and durable. The fact that it also possesses a smooth surface means that gel is easy to flush out of the structural element, and any water that flows against the structural element in a barrage generates little friction, which renders the undermining of a barrage more difficult.

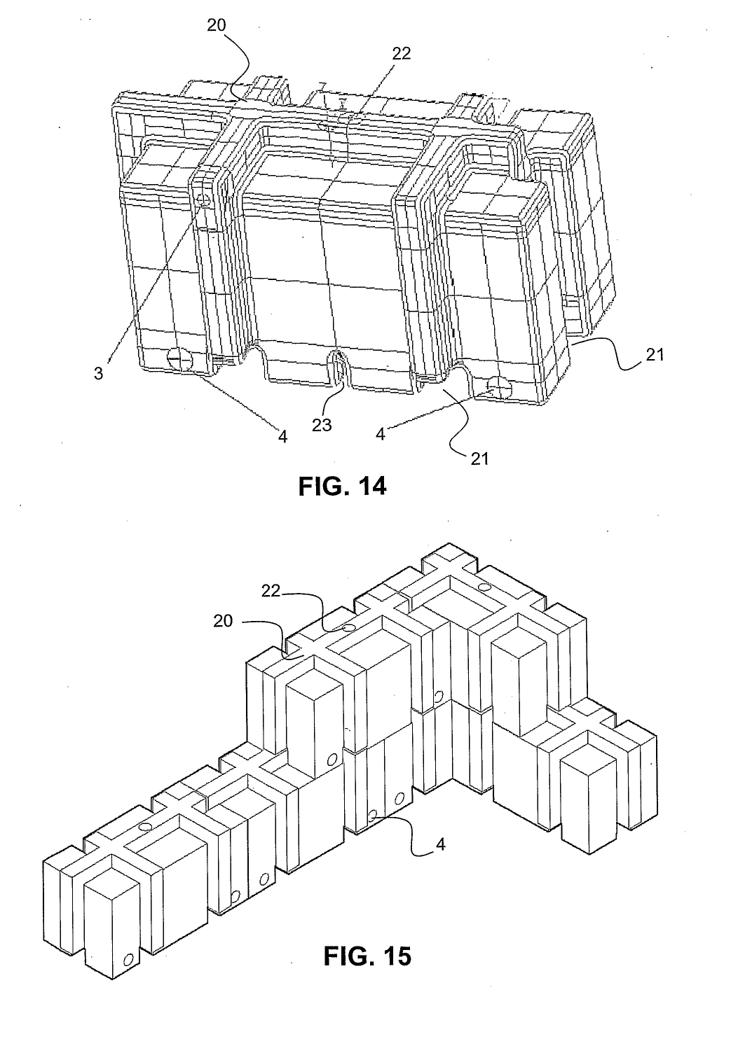

A second embodiment of a structural element according to the present invention is now described with reference to FIGS. 13-15. In this second embodiment of a structural element, the description will concentrate primarily on its configuration, since its other functions and characteristics correspond to those of the first embodiment described above.

The structural element is configured in such a way that it is able, using only structural elements of similar configuration, to construct a protective wall containing right angles and offset courses. A structural element can be displaced upwards and downwards in a direction towards a subjacent, similarly configured structural element. In directions other than the upward and downward direction of displacement, the structural element is locked against displacement relative to the subjacent, similarly configured structural element. This is achieved advantageously by means of a cross-shaped projection 20 on an upper supporting surface of the structural element and a corresponding lower projection 21 on a lower supporting surface of the structural element. The projection 20 and the recess 21 can also be positioned inversely, although the structural element will have greater contact with the ground with the recess 21 facing downwards, which provides greater stability than in the inverse case.

The structural element preferably exhibits a generally right parallelepipedic form, for example 1200×800×600 mm, which facilitates its assembly into a temporary wall. With a length that is twice as long as the width, it is easy to construct courses with an offset of half a length, which provides good holding strength for a protective wall, and it is also easy to use an offset of half a length for the purpose of locking between courses in the case of right-angled structures and T-shaped structures.

Other opposing pairs of sides of a structural element of right parallelepipedic form also advantageously include a projection and a corresponding recess, in order to be able to lock elements in every course relative to one another and to create locking at right angles and in T-shaped intersections.

The structural element is illustrated with two upper filling orifices 3 in the uppermost projection of the structural element and two lower drain orifices 4 on the lower edge of one long side of the structural element. It is easier to empty the contents from the structural element with a plurality of drain orifices than it is with fewer orifices, although it is sufficient to have a single orifice on the lower edge of a structural element in order to be able to empty it of water tolerably well before dismantling a protective wall. It is advantageous if the two filling orifices 3 are not positioned above the structural element in a rectilinear manner, so that the splinters from a bomb enclosed within the protective wall have an extremely small chance of penetrating the structural element through the two filling orifices 3, which represent a slightly weakened point compared with other parts of the structural element. The filling orifices 3 are arranged advantageously with a bayonet mounting, so that a fire hose, for example, can be readily attached thereto. An ordinary fire engine has twelve connections for fire hoses, and by connecting twelve structural elements in a protective wall to a fire engine, these can be filled simultaneously at a safe distance from the protective wall, which does not serve as a protective wall until it has been filled with water, or even better with a gel-like mass. The pressure in a fire hose is usually significantly higher than necessary in order to fill a structural element with water, and by branching a fire hose, it is possible to connect a single hose to more than one structural element, in which case a fire engine can be used to fill more than twelve structural elements at the same time.

The structural element also advantageously comprises a ventilation orifice 22 to permit air to escape as water flows in under pressure. With an orifice size of one or more centimetres, air is readily able to flow out of the structural element, and at the same time it is not necessary to provide a lid as a closure.

The structural element also advantageously includes a chamfered recess 23 on the lower edge of the long side, which recess 23 is so arranged as to receive a tent peg, or an equivalent device, for the purpose of securing the structural element to the ground, which may be appropriate for its use as a barrage, for example.

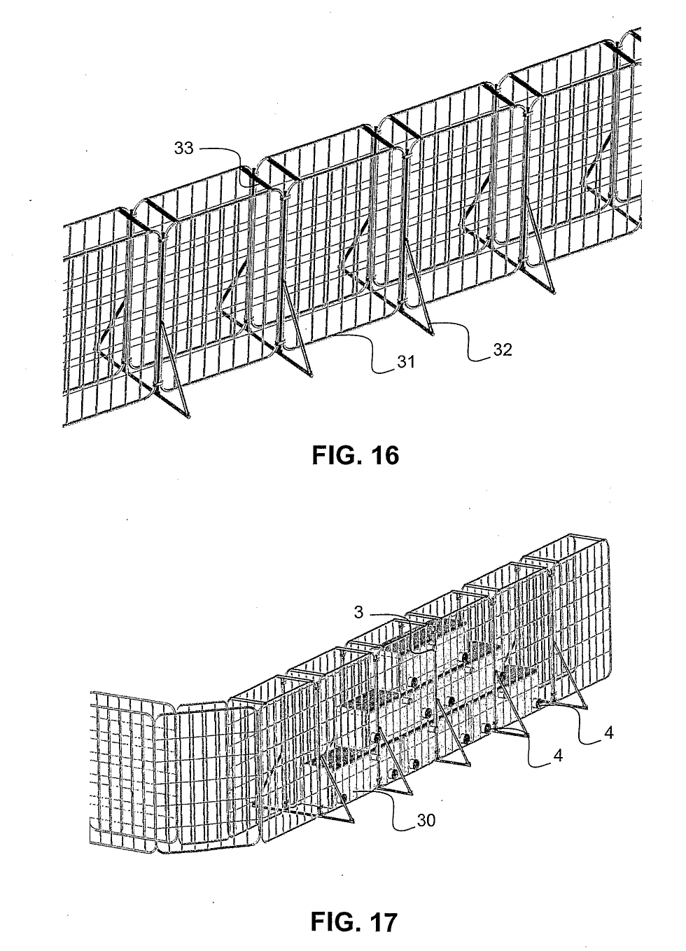

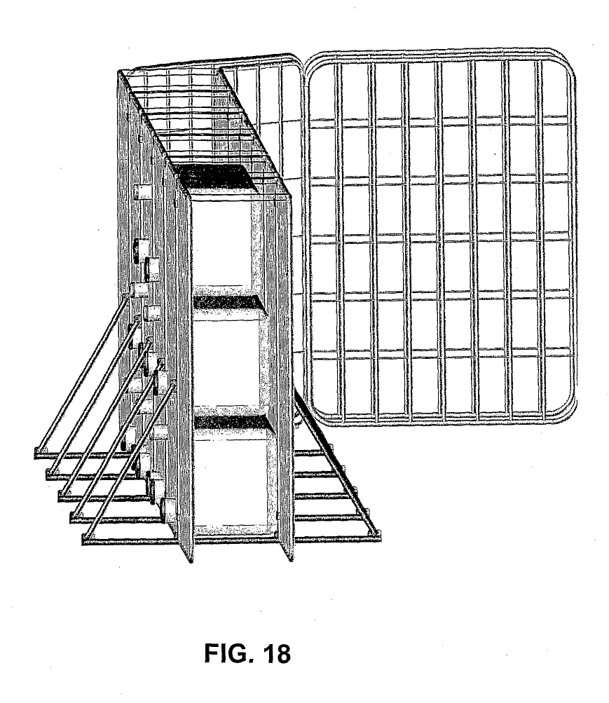

A third embodiment of the present invention will now be described with reference to FIGS. 16-18. Functions and applications as described above for the previous embodiments of the present invention are applicable also for this third embodiment of the present invention. The structural differences are described in the following.

A protective wall, stable during filling of e.g. water without risking offsetting e.g. a bomb to be disarmed, comprises a plurality of similarly configured structural hollow elements 30 positioned between two parallel self-supported screens 31. The similarly configured structural hollow elements 30 are flexible and comprises an upper filling orifice 3 and two lower drain orifices 4, and have a parallelepipedic shape when filled with water or similar.

The upper filling orifice 3 is preferably arranged to protrude out of one of the two parallel self-supported screens 31 to facilitate filling of the similarly configured structural hollow elements 30. Also the lower drain orifices 4 are preferably arranged to protrude out of one of the two parallel self-supported screens 31 to facilitate draining of the similarly configured structural hollow elements 30.

The flexible material is e.g. textile, rubber, plastic, or a combination of these materials. The flexibility, and thus the collapsibility, of the flexible material is used to store and transport empty structural hollow elements 30 in an efficient way by occupying minimal space. Also the screens occupy minimal space when stored and transported. Further, the flexibility of the flexible material allows a structural hollow element 30 to be positioned in a 45 degree configuration wall, still allowing it to be filled and take a shape of a broken parallelepipedic shape.

When a protective wall is to be erected the following steps are performed. A self-supported screen is erected, preferably with support legs 32. The structural hollow elements are positioned in overlapping courses. A second self-supported screen is erected parallel with the first screen, which screens thereafter are locked together in their top 33. The structural hollow elements of the bottom course are filled with water, and possibly also a superabsorbent. After the bottom course is filled with water, courses there above are successively filled.

It is obvious that the present invention can be varied in a large number of ways. For example, a structural element can be filled with other viscous substances instead of water, or even with running solid material such as sand. Furthermore, the protective wall described here is constructed from largely a single kind of structural element to permit its simple manufacture and storage, although it is possible, of course, to use structural elements of several different kinds in order to obtain special structures. Such variations must not be regarded as a deviation from the scope of the present invention. All such variations that are obvious to a person skilled in the art are considered to be included within the scope of the present invention according to the Claims attached hereto.

1. Structural element for a protective wall, wherein the structural element comprises of a rigid, hollow body having upper and lower, essentially parallel sides and interjacent side sections and is configured in such a way that it can be positioned above a similarly configured structural element, and in that it is locked to prevent displacement orthogonally in relation to a subjacent, similarly configured structural element by such positioning, and in that the structural element comprises at least one filling orifice in the upper part of the structural element and at least one drain orifice on the lower edge of one of the side sections of the structural element.

2. Structural element according to claim 1, the structural element having a length that is twice as long as its width.

3. Structural element according to claim 1, comprising projections in at least two different directions on the upper side of the structural element and corresponding recesses on the lower side of the structural element.

4. Structural element according to claim 3, the aforementioned at least one filling orifice being arranged in the aforementioned projection.

5. Structural element according to claim 4, comprising a least a second filling orifice arranged on the opposite side of the structural element in relation to the aforementioned at least one filling orifice, but not positioned above it in a rectilinear manner.

6. Structural element according to claim 3, the aforementioned projection being configured as an elongated projection having two intersecting, elongated projections.

7. Structural element according to claim 6, the aforementioned one elongated projection being arranged symmetrically along the middle of the aforementioned upper side, and the aforementioned two intersecting, elongated projections being arranged perpendicularly to the aforementioned one elongated, symmetrically and transversely in relation to the middle of the aforementioned upper side.

8. Structural element according to claim 1, containing a ventilation hole in the upper side.

9. Structural element according to claim 1, containing a superabsorbent in its interior.

10. Protective wall comprising at least two courses containing a plurality of structural elements according to claims 1.

11. Method for erecting a protective wall, comprising the stages:
position a plurality of similarly configured, rigid, hollow structural elements in a row,
then fill each rigid, hollow structural element in the row with water,
then position an additional number of structural elements on top of the first positioned row of structural elements, the additional number of structural elements being similarly configured to those in the first positioned row of structural elements and being locked to the first positioned row of structural elements in orthogonal directions relative to the extent of the row, the second course of structural elements being offset in the direction of the row relative to the first course of structural elements, and
then fill each additional structural element with water.

12. Method according to claim 11, comprising the stages:
empty water from the structural elements in the second course,
remove the emptied structural elements from the first course, and
empty water from the structural elements in the first course.

13. Protective wall comprising a plurality of similarly configured structural hollow elements positioned between two parallel self-supported screens, wherein said similarly configured structural hollow elements are made of a flexible material and comprises an upper filling orifice and a lower drain orifice, wherein said similarly configured structural hollow elements have a parallelepipedic shape when filled with water or similar.

14. Protective wall according to claim 13, wherein said upper filling orifice is arranged to protrude out of one of said two parallel self-supported screens to facilitate filling of said similarly configured structural hollow elements.

15. Protective wall according to claim 12, wherein said lower drain orifice is arranged to protrude out of one of said two parallel self-supported screens to facilitate draining of said similarly configured structural hollow elements.
